(19) United States
(12) Patent Application Publication
(10) Pub. No.: US 2016/0199933 A1
(43) Pub. Date: Jul. 14, 2016

(54) Friction Stir Tool, Method for Manufacturing the Same, and Friction Stir Method

(71) Applicant: EADS DEUTSCHLAND GMBH, Ottobrunn (DE)

(72) Inventors: Juergen SILVANUS, Unterhaching (DE); Tommy BRUNZEL, Meerane (DE); Katja SCHMIDKE, Muenchen (DE)

(21) Appl. No.: 14/654,212

(22) PCT Filed: Dec. 9, 2013
(86) PCT No.: PCT/DE2013/000787

§ 371 Date: Jun. 19, 2015

(30) Foreign Application Priority Data
Dec. 21, 2012 (DE) 10 2012 025 140.8

(51) Int. Cl. B23K 20/12; B22D 25/02; B22F 3/105; B22F 5/00; B23K 26/342; B23K 15/00

(52) U.S. Cl. CPC B23K 20/1255; B23K 26/342; B23K 15/0086; B22F 3/1055; B22F 5/00; B22D 25/02; B22F 2005/002; B22F 2005/005; B33Y 10/00

(57) ABSTRACT

A load-optimized friction-stir tool, particularly a two-shoulder friction-stir welding tool, includes a first tool body and a pin formation projecting from the first tool body with a smaller outer diameter compared to the outer diameter of the first tool body. The first tool body and the pin formation are integrally formed and the pin formation has a material distribution in cross section that is different from a uniform distribution over a circular shape. A method for manufacturing the friction-stir tool and a friction-stir method that can be executed with the friction-stir tool are also disclosed.

### FIELD OF THE INVENTION

The invention relates to a friction-stir tool, comprising a first tool body for providing a first shoulder and a pin formation projecting from the first tool body and having a smaller outer diameter compared to the outer diameter of the first tool body. The invention further relates to a method for manufacturing such a friction-stir tool, as well as to a friction-stir method. Such a friction-stir tool can particularly be used for friction-stir welding, but a use for so-called “friction-stir processing” is also conceivable.

### BACKGROUND AND SUMMARY OF THE INVENTION

As is known, friction-stir welding (FSW) is being increasingly used in aeronautics and space technology, in rail-bound transport technology, in entertainment electronics, household goods and in automobile engineering. This joining method is characterized by a high level of potential for automation, a high level of welding efficiency (strength σ and elongation ε) as well as the elimination of the need for rivets, whereby the manufacturing costs can be reduced and the weight of structures made in this manner reduced.

During friction-stir welding as described, for example, in WO 93/10935 A1, several workpieces to be welded together are brought into contact and held in this position. In the area to be joined of the workpieces, a welding stud or a rod-like projection of a corresponding tool is introduced under a rotational movement until a shoulder arranged above the welding stud on the tool rests on the surface of the workpieces. The welding stud is generally also referred to as a “pin.” The shoulder is mounted on the tool body from which the welding stud projects. If the shoulder is resting on the surface of the workpieces and the rotating welding stud or the rotating pin is inserted, frictional heat is generated by the relative movement between tool and workpieces, so that adjacent workpiece areas assume a plasticized state in the joint area. While the rotating pin is in contact with the joint area, the tool is moved forward along the joining line of the workpieces, so that the material located around the welding stud plasticizes and then solidifies. Before the material hardens completely, the welding stud is removed from the joint area and the pieces being joined. Additional frictional heat is generated by the shoulder, which is in contact with the workpiece surface during welding, and plasticized material can thus be prevented from escaping.

Through friction-stir welding, it is possible to weld materials, such as metals, alloys thereof, metal composite materials or suitable plastic materials, for example, as a butt joint, overlapping butt joint or T-butt joint. Spot connections can also be produced, in which case a forward movement of the rotating pin that is in contact with the joint area and a translational relative movement between rotating pin and workpieces is eliminated.

However, the friction-stir technique can also be used in the repair, processing and refining of workpieces, which is usually referred to as “friction-stir processing.” In that technique, as described above, a rod-like projection—“pin”—is introduced into at least one workpiece under rotating movement (i.e., full welding is performed), in order to modify the workpiece material at least in the area of contact of the pin. For repair purposes, the rotating pin is introduced into a crack of the workpiece, for example, in order to name only one sample application. All processes in which the technique of friction-stir welding is used, which particularly include friction-stir welding methods as well as friction-stir processing methods, are referred to below as “friction-stir methods.”

For example, friction-stir tools with a shoulder and a pin projecting therefrom with a free end, such as those described in WO 93/10935 A1 or in DE 10 2005 030800 B4, can be used for such processes. Other examples of such friction-stir tools can be found in DE 101 39687 C1 or DE 100 35332 C2.

A friction-stir tool with two shoulders is known from WO 93/10935 A1. The workpieces to be processed are clamped between the shoulders and engaged through by the pin formed as a bar between the shoulders. The pin connects the two shoulders and has a circular outline contour. In such common friction-stir welding tools, the pin can be dimensioned only up to a certain maximum diameter; for example, the size of the pins depends on the thickness of the joint to be welded. However, if the stability of the pin cannot be sufficiently ensured upon enlargement of the pin, the workpieces cannot be welded.

Due to the flexural and shear loading of the pins of such two-shoulder friction-stir tools, their stability is not sufficient for all desired friction-stir methods.

A two-shoulder friction-stir tool with a multi-pin geometry is known from DE 100 31 689 B4. For this purpose, a single pin is divided by a bore or another machining method into several remaining pins. As a result, while workpieces can be joined by means of friction-stir welding, the stability of the multi-pin geometry from DE 100 31 689 B4 cannot be ensured. Particularly, the cross section is weakened as a result of a single pin being divided into several segments.

It is the object of the invention to provide a friction-stir tool which can be better adapted in a load-optimized manner to a friction-stir task to be performed. In particular, a greater variety of material connections through friction-stir welding is to be made possible.

This object is achieved by a friction-stir tool according to embodiments of the invention, as well as by a method for manufacturing a friction-stir tool and a friction-stir method according to embodiments of the invention.

According to a first aspect, the invention provides a friction-stir tool comprising a first tool body for providing a first shoulder, a pin formation projecting from the first tool body and having a smaller outer diameter compared to the outer diameter of the first tool body, and a second tool body connected to the first tool body by the pin formation for providing a second shoulder, so that the friction-stir tool is embodied as a two-shoulder tool, the first tool body, the pin formation and the second tool body being embodied integrally such that the pin formation has a material distribution in cross section that is different from a uniform circular distribution.

According to a second aspect, the invention provides a friction-stir tool comprising at least one first tool body, a pin formation projecting from the first tool body and having a smaller outer diameter compared to the outer diameter of the first tool body, at least the first tool body and the pin formation being formed as an integral component by means of a generative production method.

The integral formation of the tool body or tool bodies or of the pin formation includes a monolithic formation, a one-piece formation or a functionally integrated formation. In the generative production method, the tool body or tool bodies or the pin formation are built up layer by layer in order to form the integral formation. Particularly, the tool body or tool bodies and/or the pin formation are formed without joining or parting points.

In the friction-stir tool according to the second aspect as well, it is preferred that the pin formation have a material distribution in cross section that is different from a uniform circular distribution.

It is preferred that the pin formation has an outline contour shape in cross section that is different from a purely singular circular shape.

It is preferred that the pin formation have at least three pins projecting from the first tool body.

It is preferred that a second tool body be provided that is connected by means of the pin formation to the first tool body, the first tool body, the second tool body and the pin formation being integrally formed by the generative production method.

Preferably, a load-optimized two-shoulder friction-stir welding tool is provided.

It is preferred that a first shoulder be provided on the first tool body and a second shoulder be provided on the second tool body and that the first and the second shoulder be connected by several pins that are embodied so as to be spaced apart.

It is preferred that a first shoulder be provided on the first tool body, the first shoulder being embodied integrally on the first tool body or on a separate component, the component having a rotational speed equal to zero relative to the first tool body, and that a second shoulder be provided on the second tool body and that the first tool body and the second shoulder be integrally connected by the several spaced-apart pins. The component is particularly fixed or stationary, so that it neither performs a rotational movement relative to the first tool body nor relative to the workpieces to be welded. In other words, the first shoulder, which is embodied as a separate component, can be arranged on or attached to the friction-stir tool in a non-rotational manner.

It is preferred that the friction-stir tool have a material composition that changes axially and/or radially, for example—particularly gradually.

According to another aspect, the invention provides a manufacturing method for manufacturing a friction-stir tool having at least one first tool body and a pin formation that projects from the first tool body, characterized by the integral manufacture and/or formation at least of the first tool body and the pin formation by means of a generative production method.

The integral formation of the tool body or tool bodies or of the pin formation includes a monolithic formation, a one-piece formation or a functionally integrated formation. In the generative production method, the tool body or tool bodies or the pin formation are built up layer by layer in order to form the integral formation. Particularly, the tool body or tool bodies and/or the pin formation are manufactured or formed without joining or parting points.

One preferred embodiment of the manufacturing method is characterized by integral production of the first tool body, the pin formation and a second tool body connected via the pin formation to the first tool body, particularly by means of a generative production method or by casting.

One preferred embodiment of the manufacturing method is characterized by execution of the generative production method such that more than two spaced-apart pins projecting from the first tool body are produced which form the pin formation. One preferred embodiment of the manufacturing method is characterized by the use of a powder-based method as a generative production method. Advantageously, a laser or electron beam is used as a heat source for fusing a metal powder or metal alloy powder. For example, a powder bed method can be used in which the metal powder or metal alloy powder is applied in layers and fused by means of the heat source. Alternatively or in combination with the powder bed method, the metal powder or metal alloy powder can be atomized by means of at least one powder nozzle and applied in layers.

One preferred embodiment of the manufacturing method, which is used for the manufacture of a friction-stir tool for a predetermined friction-stir welding task, is characterized by estimation or calculation of the loads acting during the friction-stir welding task on the pin formation, and determination of a material distribution of the pin formation—particularly changing over the overall cross section of the pin formation—as a function of the estimated or calculated loads. The execution of the generative production method is such that the pin formation with the specific material distribution is manufactured.

It is preferred that the determination of the material distribution comprises:

a) selection of a number of spaced-apart pins which, together, form the pin formation,

b) selection of a cross-sectional contour and/or of a pressure gauge for at least one of several spaced-apart pins which, together, form the pin formation, and/or

c) determination of the arrangement and/or of the spacing between several pins which, together, form the pin formation, and/or

d) selection of a material distribution which changes axially and/or radially, e.g., of a gradient material for at least one pin of the pin formation.

One advantageous embodiment of the manufacturing method is characterized by the use of different materials and/or different combinations of materials in the generative production method at different points of the friction-stir tool in order to thus obtain at least one material characteristic that changes in the friction-stir tool—e.g., radially or axially.

According to another aspect, the invention provides a friction-stir method in which friction-stirring is performed by means of a friction-stir tool according to the invention or advantageous embodiments thereof and/or in which the friction-stirring is performed by means of a friction-stir tool that was manufactured using the manufacturing method according to the invention or of one of its advantageous embodiments.

Preferably, at least the first tool body and the pin formation are manufactured as an integral or monolithic component, particularly using a generative production method or other methods, such as casting or the like. Particularly, the first tool body, the second tool body and the pin formation connecting the tool bodies are manufactured together integrally from a monolithic block. As a result, there are no parting points or weaknesses of any kind such as those which can be caused by machining methods. This makes it possible to absorb the enormous loads that can occur in a two-shoulder tool, particularly in the area of the transition between tool body and pin formation. Only in this way are many welding tasks made possible that could not previously be carried out by means of friction-stir welding.

Through the generative production method, the material of the pin formation can particularly be distributed in a load-optimized manner, e.g., optimized for a certain friction-stir task. For instance, the outline contour of the pin formation can be different from a purely circular shape. For example, a pin formation with several pins, with equal or different cross sections, each with circular cross section or other cross sections, can easily be manufactured. Moreover, it is also possible, for example, to obtain a material composition for the pin formation that changes over the cross section.

In particular, it is also possible to produce complicated outline shapes without cross-sectional weakening as a pin formation. Particularly, a pin can be produced integrally with the first tool body that has an outline contour shape that is different from a single circular shape.

Especially preferably, a plurality of, particularly more than two, corresponding thinner pins are used as a pin formation which, together with at least the first tool body, are manufactured in a generative production method as an integral component. For example, instead of a single, thick pin, a plurality of, greater than two, thin pins are used.

Especially preferably, the friction-stir tool is a multi-shoulder tool, with several tool bodies being interconnected by one or more pin formations. A shoulder can be embodied on each of the respective tool bodies. Each shoulder can be embodied directly on the tool body in one piece. It is also possible, however, for the shoulder to be embodied on a separate component, the component having a rotational speed equal to zero relative to the first tool body. The component is particularly fixed or stationary, so that it performs no rotational movement relative to the first tool body and relative to the workpieces to be welded. In other words, the shoulder embodied as a separate component can be arranged in or attached to the friction-stir tool in a non-rotational manner.

Preferably, several thin pins connect the tool bodies. For example, a plurality of, i.e., more than two, pins are used to interconnect the tool shoulders. This combination of several shoulders and several pins is also manufactured by means of additive production or by means of generative production methods as an integral component.

Preferably, powder-based methods are used as the generative production method. Advantageously, a laser or electron beam is used as a heat source for fusing a metal powder or metal alloy powder. For example, a powder bed method can be used in which the metal powder or metal alloy powder is applied in layers and fused by means of the heat source. Alternatively or in combination with the powder bed method the metal powder or metal alloy powder can be atomized by means of at least one powder nozzle and applied in layers.

The structure of the friction-stir tool can be optimally adapted to the load occurring by means of generative production methods. Accordingly, the geometry and the cross section of the pin formation, particularly the geometry and the cross section of several pins which form the pin formation, are not subject to the manufacturing-related limits of rotation (as a machining production method), but can be optimized by flow mechanics.

Particularly when using several pins as the pin formation, the friction-stir tool has a greater level of rigidity compared to a single central pin due to the substantially higher geometrical moment of inertia. This effect is known in mechanical strength theory as the “parallel axis theorem.”

The structural liberties of the generative production method enable the construction of the tool combination as an integral component without strength-weakening joining point(s).

In such generative production methods, it is also possible to build up the friction-stir tool at different places with different materials or different combinations of materials. Particularly, different combinations of materials—gradient materials—can be used. The changes in the material characteristics can be influenced and shaped through the targeted introduction and use of appropriate materials, it being possible for changes in the radial or axial direction to occur not only in steps but also gradually.

Different materials can also be used. For example, electron beam sintering methods or laser sintering methods can be used in order to enable the use of a plurality of different possible alloys, for example.

### BRIEF DESCRIPTION OF THE DRAWINGS

Exemplary embodiments of the invention are explained in further detail below with reference to the enclosed drawings.

FIG. 1 shows a top view of a friction-stir tool, here, for example, in the form of a two-shoulder tool for a friction-stir welding method—according to the prior art;

FIG. 2 shows a section along line II-II through the friction-stir tool according to the prior art;

FIG. 3 shows a view comparable to that of FIG. 1 of a friction-stir tool according to one embodiment of the invention in the form of a two-shoulder tool for a friction-stir welding method;

FIG. 4 shows a section along line IV-IV for a first embodiment of the friction-stir tool according to the invention;

FIG. 5 shows a section along line IV-IV of FIG. 3 for a second embodiment of the friction-stir tool according to the invention;

FIG. 6 shows a section along line IV-IV of FIG. 3 for a third embodiment of the invention;

FIG. 7 shows a configuration of pins for one of the pin formations of a friction-stir tool according to FIGS. 3 to 6;

FIG. 8 shows a comparative representation of sectional views through a friction-stir tool according to the prior art comparable to that of FIG. 2 and through a friction-stir tool according to an embodiment of the invention comparable to that of FIG. 4 for the purpose of deducing and representing different rigidities of the respective pin formations of the friction-stir tools;

FIG. 9 shows a schematic representation of a first friction-stir tool manufacturing device for manufacturing the inventive friction-stir tools according to the representations of FIGS. 3 to 6 by means of a generative production method;

FIG. 10 shows a section through an embodiment of a friction-stir tool according to the invention, as shown to the right in FIG. 8 along an x-z plane in order to depict a friction-stir tool with a gradient material;

FIG. 11 shows a second embodiment of a friction-stir tool manufacturing device for manufacturing one of the inventive friction-stir tools according to the embodiments of FIGS. 3 to 6 by means of a generative production method;

FIG. 12 shows a section through a friction-stir tool according to another embodiment of the invention that can be manufactured using the friction-stir tool manufacturing device of FIG. 11, the section having been made along the x-z plane of FIG. 8 in order to illustrate another example of a friction-stir tool with gradient material; and

FIG. 13 shows a section through another embodiment of a friction-stir tool.

### DETAILED DESCRIPTION OF THE DRAWINGS

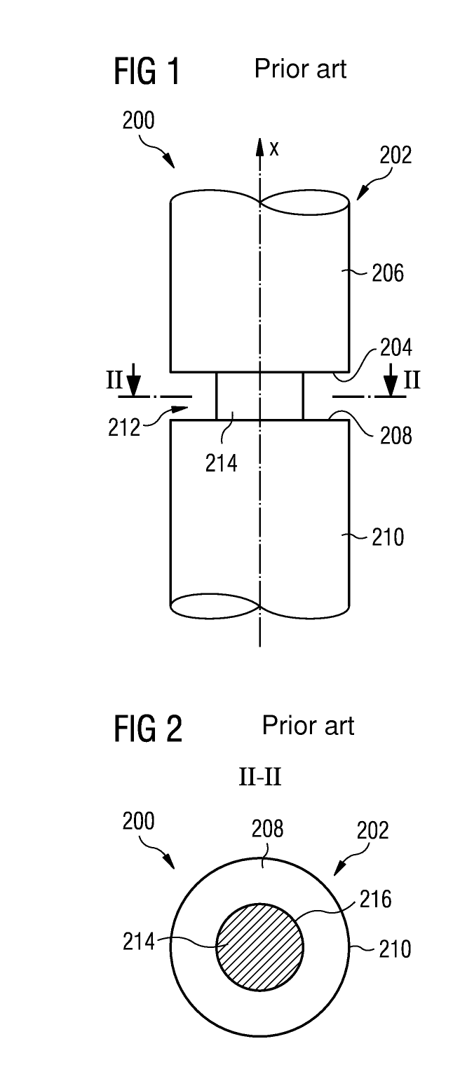

FIGS. 1 and 2 show a friction-stir tool 200 according to the prior art, the friction-stir tool 200 being provided as a two-shoulder tool 202 with a first tool body 206 having a first shoulder 204, a second tool body 201 having a second shoulder 208, and a pin 212 connecting the first tool bodies 206 and the second tool body 210.

The first tool body 206 and the pin 212 of the known friction-stir tool 200 projecting therefrom are formed from one piece using a turning method, the pin 212 being formed by material-removing turning of the first shoulder 204 as a single circular pin 214 with an outline contour shape 216 embodied as a single circle.

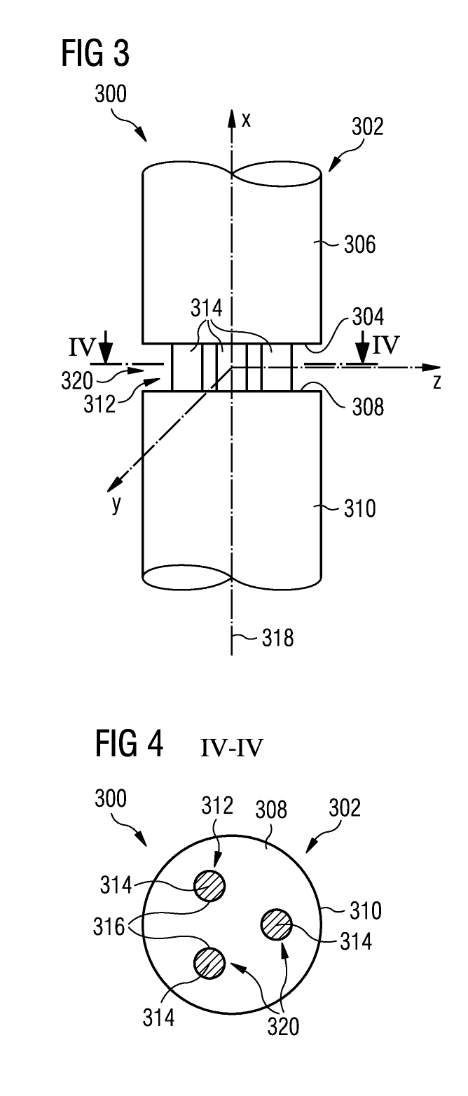

In contrast, FIG. 3 shows a friction-stir tool 300 according to one embodiment of the invention, the friction-stir tool 300 also being embodied in the depicted example as a two-shoulder tool 302 for executing a friction-stir welding method such that a first shoulder 304 is embodied on a first tool body 306 and a second shoulder 308 is embodied on a second tool body 310, and that the first tool body 306 and the second tool body 310 are interconnected by a pin formation 312.

The pin formation 312 projects from the first tool body 306 with a smaller outer diameter, so that the first shoulder 304 is formed around the pin formation 312. The pin formation 312 is also connected to the second tool body 310 embodied with a larger outer diameter, so that the second shoulder 308 is embodied thereon around the pin formation 312. The overall friction-stir tool 300 is manufactured in one piece using a generative production method.

The manufacture by use of a generative production method makes it possible to embody the pin formation 312, unlike the form of the known friction-stir tool 200 shown in FIG. 2, not with a material distribution that is uniform over a circular surface, but with a material distribution 320 that differs therefrom.

In particular, the generative production method makes it possible in a simple manner to embody the pin formation 312 in a manner that differs from the form of the known friction-stir tool 200 shown in FIG. 2 with an outline contour shape 316 that differs from a single circular shape, it being possible to structure the outline contour shape 316 however desired without weakening the pin formation 312 in cross section through machining processes.

FIGS. 4 to 6 each show possible exemplary embodiments for the pin formation 312 in section along line IV-IV of FIG. 3.

The pin formation 312 is preferably embodied as a group of several pins 314, with more than two pins 314 being preferred for stability-related reasons.

FIG. 4 shows a first embodiment of the pin formation 312 with a total of three uniformly grouped pins 314, the individual pins 314 being spaced apart from one another.

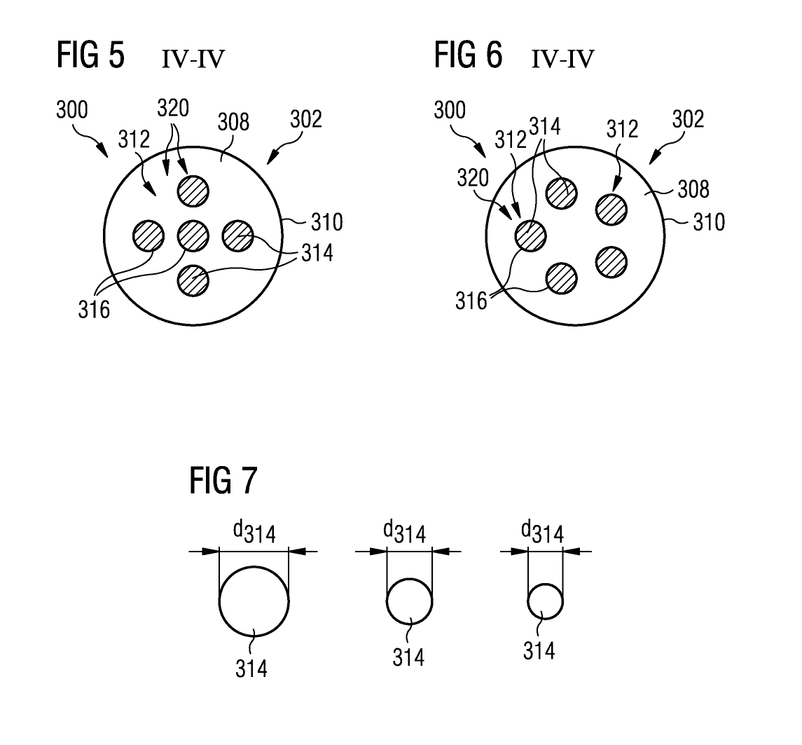

FIG. 5 shows an example of a first arrangement of a total of five pins 314, and FIG. 6 also shows a pin formation 312 with a total of five pins 314, but with the pins 314 in a different arrangement than in FIG. 5.

The pins 314 can have any cross-sectional shapes; in the depicted exemplary embodiments, a circular profile formation of the pins 314 with outer diameter d₃₁₄ is shown for the sake of example.

As FIG. 7 shows, the pins 314 can have different diameters d₃₁₄, with the diameters d₃₁₄=6 mm, d₃₁₄=4 mm and d₃₁₄=3 mm being indicated here, for example; pins 314 with diameters of two millimeters are also conceivable.

As will readily be understood, instead of the circular profile cross sections shown, the pins 314 can also have profile cross-sectional shapes which differ therefrom.

All of the examples of FIGS. 4 to 6 show pin formations 312 that differ in their outline contour shape 316 from the known outline contour shape 216, which only has a single circular shape.

The arrangement of the pins 314, the selection of the cross-sectional surface of the pins 314, the outline contour shape 316, and preferably also the material are appropriately selected and set depending on the load on the friction-stir tool 300 to be expected.

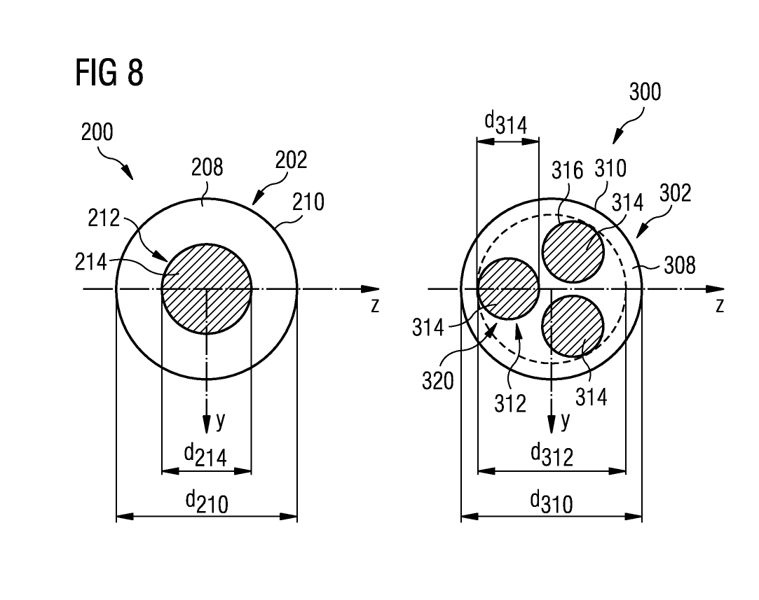

As is explained below in further detail with reference to FIG. 8, due to the higher geometrical moments of inertia, there is a substantially higher level of stability in the pin formation 312 according to the invention even if the cross-sectional surface of the pin formation 312 is the same as that of the known pin formation 212 or only slightly larger than the cross-sectional surface of the known pin formation 212.

During friction-stir welding or other friction-stir methods, heat is generated through friction, with the frictional heat being generated particularly through rubbing with at least the first shoulder 304 or with the first shoulder 304 and the second shoulder 308. Besides the generation of frictional heat, the shoulders 304, 308 also have the function of keeping the plasticized material in the processing area and preventing excessive flow-off. For this reason, the engaging surface of the shoulders 304, 308 with which they engage with the workpieces should not be too small. Given that the pin formation 312 has several pins 314, this engaging surface of the shoulders 304, 308 can be held up even if the pins 314 are arranged at least partially nearer toward the outer periphery of the tool bodies 306, 310.

In the left subfigure, FIG. 8 shows the known pin formation 212 with purely circular outline contour shape 216, the single pin 214 having a diameter d₂₁₄ of 6 mm, for example. In this example, the outer diameter d₂₁₀ of the corresponding tool body 206, 210 is 12 mm. In the right subfigure, FIG. 8 also shows, for comparison, a friction-stir tool 300 according to one embodiment of the invention with an embodiment of the pin formation 312 with a total of three pins 314. Here, too, the diameter d₃₁₀ of the tool bodies 306, 310 is assumed to be about 12 mm, for example. The pin formation 312 is inscribed in a circle having a diameter d₃₁₂ of about 10 mm. Here, the diameter d₃₁₄ of the individual pins 314 is about 4 mm, for example.

For the surface area A of such circular pins 214, 314 having diameter d, the following applies:

$$A = {d}^{2} \frac{π}{4} \qquad Equation ( 1 )$$

Accordingly, for the surface area A₂₁₂ of the known pin formation 212, we have:

$${A}_{212} = {d}_{214}^{2} \frac{π}{4} = 36 {mm}^{2} \frac{π}{4} \approx 28.26 {mm}^{2} \qquad Equation ( 2 )$$

For the surface area of the pin formation 312 of the inventive embodiment of FIG. 8, the following applies:

$${A}_{312} = 3 \cdot {d}_{314} \frac{π}{4} = 3 \cdot {( 4 mm )}^{2} \cdot \frac{π}{4} \approx 37.68 {mm}^{2} \qquad Equation ( 3 )$$

Accordingly, the surface area A₂₁₂ of the known pin formation 212 is somewhat smaller than the surface area A₃₁₄ of the inventive embodiment.

For the geometrical moment of inertia I_{y,z} of a circular pins having diameter d, the following applies:

$${I}_{y , z} = \frac{π \cdot {d}^{4}}{64} \qquad Equation ( 4 )$$

Accordingly, the geometrical moment of inertia of the known pin formation 212 having diameter d₂₁₄=6 mm is as follows:

$${I}_{y ; 212} = \frac{π \cdot {( 6 mm )}^{4}}{64} \approx 63.6 {mm}^{4} \qquad Equation ( 5 )$$

Due to the additional “parallel axes theorem,” for the pin formation 312 with several pins 314, we have:

I_{y}=Σ(I_{y,i}+αᵢ²Aᵢ) Equation (6)

where i is the respective pin 314 and aᵢ is the distance of the i-th pin 314 from the y-axis.

Accordingly, the geometrical moment of inertia I_{y,312} for the pin formation 312 shown to the right in FIG. 8 is:

$${I}_{y , 312} = ( {I}_{y 1} + {a}_{1}^{2} {A}_{1} ) + ( {I}_{y 2} + {a}_{2}^{2} {A}_{2} ) + ( {I}_{y 3} + {a}_{3}^{2} {A}_{3} ) \\ {I}_{y , 312} \approx ( \frac{π \cdot {( 4 mm )}^{2}}{64} + {( 1.5 mm )}^{2} \cdot 12.56 {mm}^{2} ) + ( \frac{π \cdot {( 4 mm )}^{2}}{64} + {( 1.5 mm )}^{2} \cdot 12.56 {mm}^{2} ) + ( \frac{π \cdot {( 4 mm )}^{2}}{64} + {( 3 mm )}^{2} \cdot 12.56 {mm}^{2} ) \qquad Equation ( 7 )$$

### That is:

I_{y,312}≈207 mm⁴ Equation (8)

In the pin formation 312 according to the inventive embodiment, the geometrical moment of inertia I_{y,312} is therefore larger than the geometrical moment of inertia I_{y,212} of the known pin formation 212 by about a factor of 3.3.

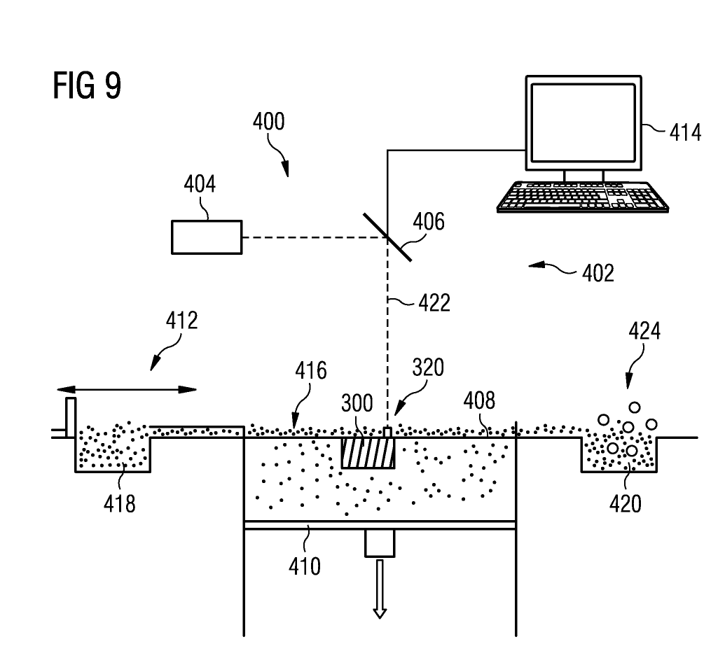

In the following, various embodiments of a manufacturing device for manufacturing the friction-stir tools 300 according to the inventive embodiments and methods that can be executed therewith for manufacturing such friction-stir tools 300 are explained in further detail with reference to FIGS. 9 to 12.

FIG. 9 shows a first embodiment of a manufacturing device 400 for manufacturing a friction-stir tool 300 through execution of a generative production method.

The manufacturing device 400 is embodied as a laser beam or electron beam powder bed-manufacturing device 402. The manufacturing device 400 has an energy beam generation device 404, an energy beam guidance device 406, a powder bed 408 with a moveable manufacturing platform 410 and a powder application device 412. Furthermore, a control device 414 is provided for controlling the manufacturing method. In particular, the control device 414 controls the energy beam guidance device 406, the manufacturing platform 410, and the powder application device 412.

The energy beam generation device 404 is for generating a high-energy beam with which the material powder can be converted into a solid form. For example, the energy beam generation device is used to generate a high-energy laser beam or an electron beam with which the material powder 416 can be melted and/or sintered.

The material powder 416 can be applied from a first powder reservoir 418 and/or a second powder reservoir 420 by means of the powder application device 412 in thin powder layers on the manufacturing platform 410.

Data on the shape of the friction-stir tool 300—CAD data, for example—are inputted into the control device 414; the control device 414 then diverts the energy beam 422 by means of the energy beam guidance device 406 such that the entire cross section of the friction-stir tool 300 is solidified at the level of this layer. Subsequently, the control device 414 lowers the manufacturing platform 410 by a certain amount in order to apply the next layer of powder and solidify the cross section again.

Using this inherently known laser or electron beam-powder bed method, the friction-stir tool 300 according to the illustrations in FIGS. 3 to 8 can be manufactured integrally as a single piece.

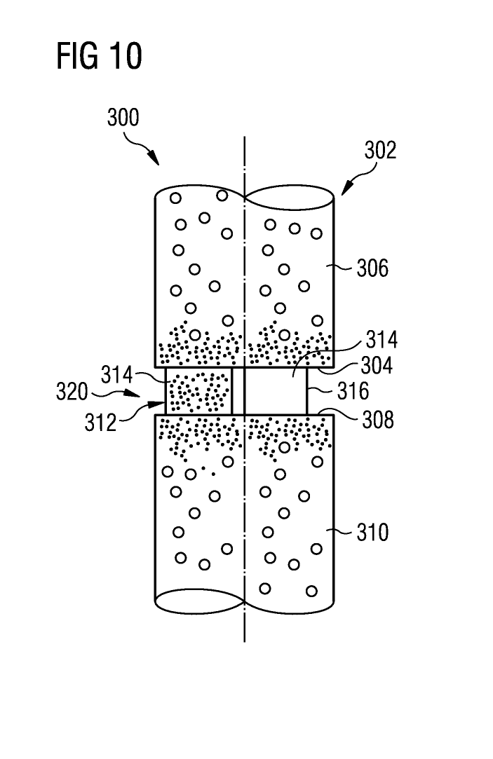

Furthermore, with the manufacturing device 400 shown in FIG. 9, it is possible to apply different material powders 416 in different layers. For example, the first powder reservoir 418 contains a first material powder 416 and the second powder reservoir 420 contains a second material powder 424. Thus, optionally either the first material powder 416 or the second material powder 424 or also mixtures with different compositions of the first material powder 416 and of the second material powder 424 can be applied by means of the powder application device 412 in different layers. As a result, changing material characteristics can be obtained along the axis 318 of the friction-stir tool, as is shown on the basis of the example of the friction-stir tool 300 in FIG. 10.

FIG. 10 shows a friction-stir tool 300 according to one embodiment of the invention, the structure in this example corresponding to that shown to the right in FIG. 8. FIG. 10 shows a section along an x-z plane of FIG. 8. The materials contained from the different material powder in 416, 424 are indicated by dots and circles.

For example, more elastic material characteristics can be obtained at the edge of the tool bodies 306, 310, so that one of the tool bodies 306, 310 is well suited to clamping in a clamping device (not shown), with a harder material being used, for example, in the area of the shoulders 304, 308 and/or in the area of the pin formation 312.

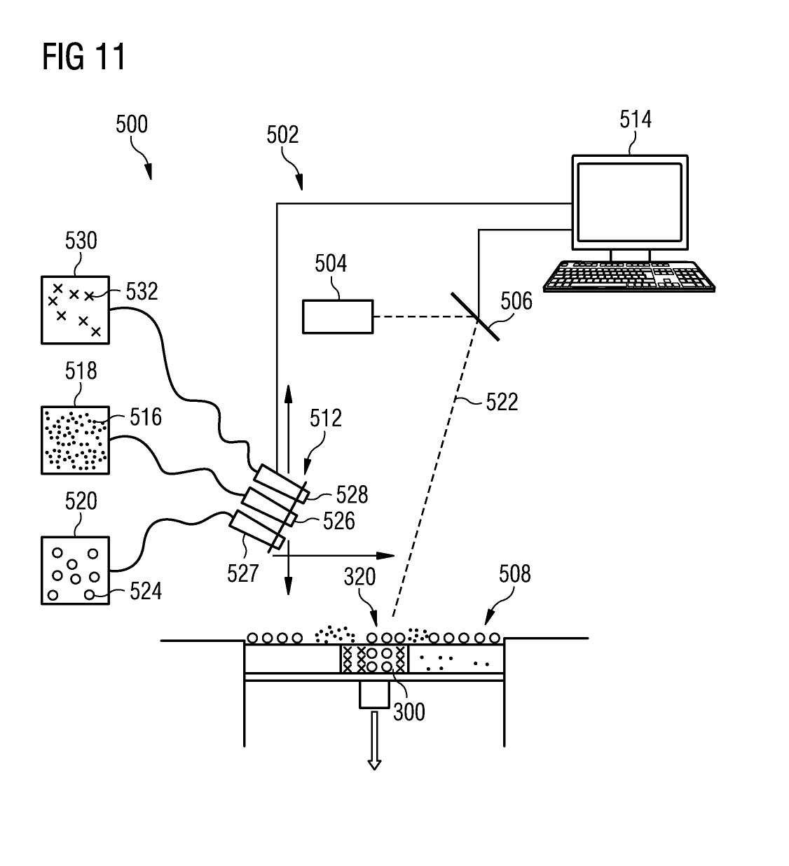

FIG. 11 shows another embodiment of a manufacturing device 500 for manufacturing the friction-stir tool 300 according to one embodiment of the invention. With this manufacturing device 500 as well, a generative production method can particularly be executed in the form of a laser or electron beam-powder bed method. Accordingly, this manufacturing device 500 is preferably also outfitted as a laser or electron beam powder bed device 502 with an energy beam generation device 504, an energy beam guidance device 506, a powder bed 508 with manufacturing platform 510 and a powder application device 512 for applying different material powders 516, 524. A control device 514 guides and controls the manufacturing process of the manufacturing device 500.

Unlike in the manufacturing device 400, however, the powder application device 512 is embodied such that different materials can be mounted on different places on the manufacturing platform 410. For this purpose, the powder application device 512 is equipped with several powder nozzles 526, 527, 528 that are connected to different powder reservoirs 518, 520, 530. For this purpose, a first powder nozzle 526 is connected to a first powder reservoir 518 with a first material powder 516 in order to apply the first material powder 516. A second powder nozzle 527 is connected to a second powder reservoir 520 with a second material powder 524 in order to apply this second material powder 524. A third powder nozzle 528 is connected to a third powder reservoir 530 in order to apply a third material powder 532. The powder application device 512 can be controlled by the control device 514 such that at least one of the material powders—or mixtures thereof—516, 524, 532 can optionally be applied anywhere on the y-z plane (parallel to the manufacturing platform 519).

Otherwise, the manufacturing device 500 is constructed analogously to the manufacturing device 400, so that the friction-stir tool 300 can also be constructed from CAD data using an additive production method using this manufacturing device 500.

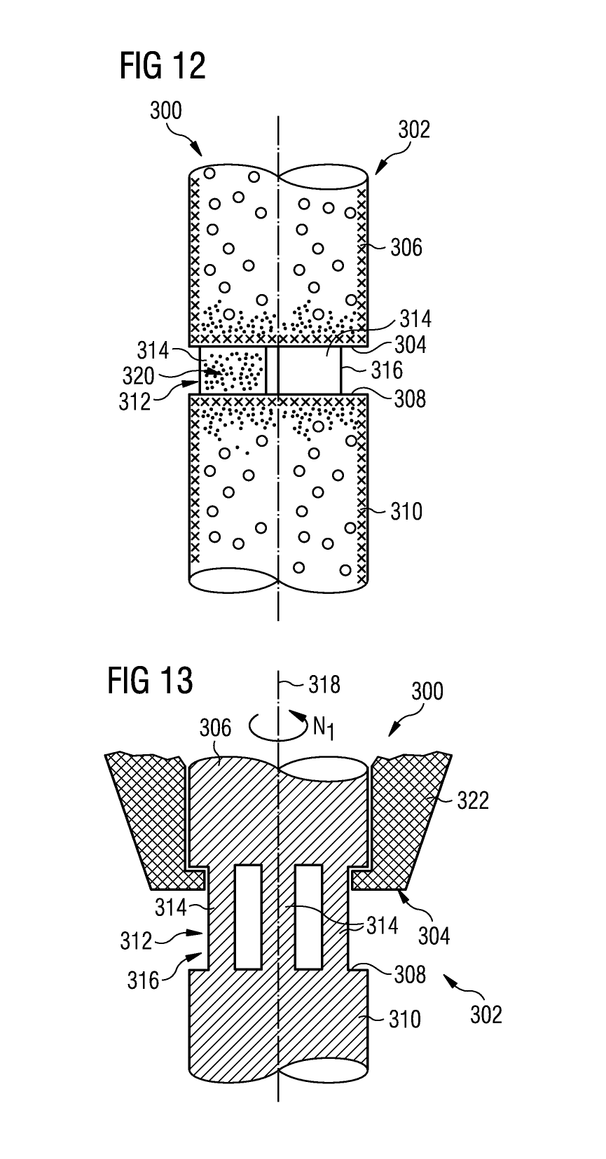

FIG. 12 shows a section through a friction-stir tool 300 according to another embodiment that can be manufactured using the manufacturing device 500 of FIG. 11. The three different materials that can be obtained through the three material powders 516, 524, 532 are indicated in different distribution within the friction-stir tool 300. For example, the surfaces can be hardened here or otherwise adapted to the loads to be expected in the friction-stir tool 300.

A friction-stir method can be carried out with the depicted manufacturing devices 400, 500 and the friction-stir tools 300 that can be manufactured therewith as follows.

For example, the friction-stir task would be provided of interconnecting two thick metal plates in a butt joint. Depending on the thickness of the joint and the materials to be welded, loads then act on the friction-stir tool 300 and particularly on the pin formations 312 that a person skilled in the art is capable of estimating or calculating well. For this purpose, the pin formation 312 must transmit the frictional forces acting on the pin formation 312 on the one hand and, in addition, also transmit the forces that act on the second shoulder 308.

The shoulders 304, 308, the tool bodies 306, 310, and the pin formation 312 are designed according to these loads on the pin formation 312 and the shoulders 304, 308 to be estimated.

The material distribution 320 of the pin formation 312 is chosen, for example, by selecting one of the outline contour shapes 316 of FIGS. 4 to 6; moreover, the diameter of the pins 314 and the distance of the pins 314 from each other and from the axis 318 of the friction-stir tool are determined.

Alternatively or in addition to the selection of the outline contour shape 316 of the pin formation 312, a predetermined material distribution 320 that changes over the cross section can also be achieved through different introduction of the different material powders and/or mixtures thereof.

In particular, the materials are selected according to the loads to be expected. Accordingly, the friction-stir tool 300 is designed in a CAD program; the data are then put on one of the control devices 414, 514 in order to then execute the generative production method for manufacturing the designed friction-stir tool 300.

Subsequently, the friction-stir tool 300 manufactured in this way is clamped in a tool socket (not shown)—for example, a robot arm with turning device at the end of the robot arm—in order to carry out the friction-stir task of the friction-stir method.

FIG. 13 shows yet another embodiment of the friction-stir tool 300, in which the first tool body 306, the second tool body 310 and the pin formation 312 connecting the first tool body 306 to the second tool body 310 are manufactured with at least three or more spaced-apart pins 314 as a one-piece, monolithic component without joining or parting points. Here, however, the first shoulder 304 is not embodied directly on the first tool body 306, but on a separate component 322, the component 322 having a rotational speed equal to zero relative to the first tool body 306. The first shoulder 304 is stationary. As a result, a difference in rotational speed ΔN between the rotational speed N₁ of the pin formation 314 and the rotational speed of the first shoulder 304 exists. For further details and advantages of this design with different rotational speeds, reference is made to DE 10 2005 030 800 A1.

The component with the tool bodies 306, 310 and the separate component 322 with the first shoulder 304 can be constructed together in a functionally integrated manner in a manufacturing process, particularly using generative production methods as explained above.

In summary, according to one exemplary embodiment of the invention, in order to provide a load-optimized friction-stir tool 300, particularly a two-shoulder friction-stir welding tool 302, a friction-stir tool 300 with a first tool body 306 and a pin formation 312 projecting from the first tool body 306 and having a smaller outer diameter compared to the outer diameter of the first tool body 306 is proposed in which the first tool body 306 and the pin formation 312 are integrally formed, particularly by means of a generative production method such that the pin formation 312 has a material distribution 320 in cross section that is different from a uniform distribution over a circular shape, such as, for example, an outline contour shape 316 that is different from a single circular shape, or a gradient material. Also proposed are a method for manufacturing the friction-stir tool 300 and a friction-stir method that can be executed using the friction-stir tool 300. In this way, a far greater variety of material processing and material joints is made possible with friction-stir welding than previously.

### LIST OF REFERENCE SYMBOLS

200 friction-stir tool (prior art)
202 two-shoulder tool (prior art)
204 first shoulder (prior art)
206 first tool body (prior art)
208 second shoulder (prior art)
210 second tool body (prior art)
212 pin
214 pin
216 outline contour shape
300 friction-stir tool
302 two-shoulder tool
304 first shoulder
306 first tool body
308 second shoulder
310 second tool body
312 pin formation
314 pin
316 outline contour shape
318 axis
320 material distribution
322 separate component with shoulder
400 manufacturing device
402 laser or electron beam powder bed device
404 energy beam generation device
406 energy beam guidance device
408 powder bed
410 manufacturing platform
412 powder application device
414 control device
416 material powder
418 first powder reservoir
420 second powder reservoir
422 energy beam
424 second material powder
500 manufacturing device
502 laser or electron beam powder bed device
504 energy beam generation device
506 energy beam guidance device
508 powder bed
510 manufacturing platform
512 powder application device
514 control device
516 first material powder
518 first powder reservoir
520 second powder reservoir
522 energy beam
524 second material powder
526 first powder nozzle
527 second powder nozzle
528 third powder nozzle
530 third powder reservoir
532 third material powder

1-15. (canceled)

16. A friction-stir tool, comprising:
a first tool body for providing a first shoulder;
a pin formation projecting from the first tool body and having a smaller outer diameter compared to an outer diameter of the first tool body; and
a second tool body connected by the pin formation to the first tool body for providing a second shoulder, wherein
the friction-stir tool is configured as a two-shoulder tool, and
the first tool body, the pin formation and the second tool body are integrally formed such that the pin formation has a material distribution in cross section that is different from a uniform circular distribution.

17. A friction-stir tool, comprising:
at least one first tool body; and
a pin formation projecting from the first tool body and having a smaller outer diameter compared to an outer diameter of the first tool body, wherein
at least the first tool body and the pin formation are formed as an integral component via a generative production.

18. The friction-stir tool according to claim 16, wherein
the pin formation has an outline contour shape in cross section that is different from a single circular shape.

19. The friction-stir according to claim 16, wherein
the pin formation has at least three pins projecting from the first tool body.

20. The friction-stir according to claim 17, wherein
the pin formation has at least three pins projecting from the first tool body.

21. the friction-stir tool according to claim 16, wherein the first tool body, the second tool body, and the pin formation are integrally formed via generative production.

22. The friction-stir tool according to claim 17, further comprising:
a second tool body connected via the pin formation to the first tool body, wherein
the first tool body, the second tool body and the pin formation are integrally formed via the generative production.

23. The friction-stir tool according to claim 16, wherein
a first shoulder is provided on the first tool body, the first shoulder being embodied integrally on the first tool body or on a separate component,
the separate component has a rotational speed equal to zero relative to the first tool body, and
a second shoulder is provided on the second tool body, wherein
the first tool body and the second shoulder are integrally connected by the several spaced-apart pins of the pin formation.

24. The friction-stir tool according to claim 20, wherein
a first shoulder is provided on the first tool body, the first shoulder being embodied integrally on the first tool body or on a separate component,
the separate component has a rotational speed equal to zero relative to the first tool body, and
a second shoulder is provided on a second tool body, wherein
the first tool body and the second shoulder are integrally connected by the several spaced-apart pins of the pin formation.

25. The friction-stir tool according to claim 16, wherein
the friction-stir tool has a material composition that changes axially or radially.

26. The friction-stir according to claim 25, wherein the changes of the material composition of the friction-stir tool are gradual changes.

27. The friction-stir tool according to claim 17, wherein
the friction-stir tool has a material composition that changes axially or radially.

28. The friction-stir according to claim 27, wherein the changes of the material composition of the friction-stir tool are gradual changes.

29. A manufacturing method for manufacturing a friction-stir tool, the method comprising the acts of:
integrally manufacturing and/or forming at least a first tool body and a pin formation projecting from the first tool body of the friction-stir tool, wherein
the integral manufacture and/or formation is carried out via a generative production method.

30. The manufacturing method according to claim 29, wherein
the integral production of the first tool body and the pin formation includes integrally producing a second tool body connected via the pin formation to the first tool body by the generative production method or by casting.

31. The manufacturing method according to claim 29, wherein
the integral production, via the generative production method, is executed such that more than two spaced-apart pins projecting from the first tool body are produced which form the pin formation.

32. The manufacturing method according to claim 29, wherein
a powder-based method is used as the generative production method for manufacturing the friction-stir tool.

33. The manufacturing method according to claim 29, wherein the manufacturing of the friction-stir tool is carried out for a predetermined friction-stir task, by:
estimation or calculation of loads acting during the friction-stir task on the pin formation,
determination of a material distribution of the pin formation comprising changing over the overall cross section of the pin formation, as a function of the estimated or calculated loads, and
execution of the generative production method such that the pin formation is manufactured with the determined material distribution.

34. The manufacturing method according to claim 33, wherein the determination of the material distribution comprises at least one of the acts of:
a) selection of a number of spaced-apart pins which, together, form the pin formation,
b) selection of a cross-sectional contour and/or of a cross-sectional surface for at least one of several spaced-apart pins which, together, form the pin formation,
c) determination of the arrangement or of the spacing between several pins which, together, form the pin formation, or
d) determination of a material distribution that changes radially or axially for at least one pin of the pin formation.

35. The manufacturing method according to claim 29, wherein different materials and/or different combinations of materials are used in the generative production method at different points of the friction-stir tool in order to obtain at least one material characteristic changing radially or axially in the friction-stir tool.
